(19) United States
(12) Patent Application Publication
(10) Pub. No.: US 2009/0297903 A1
(43) Pub. Date: Dec. 3, 2009

(54) Fuel Cell Device

(75) Inventors: Tomohiro Hirayama, Ome-shi (JP); Terumasa Nagasaki, Ome-shi (JP); Nobuyasu Tajima, Akishima-shi (JP); Takahiro Suzuki, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/349,425

(22) Filed: Jan. 6, 2009

(30) Foreign Application Priority Data
May 28, 2008 (JP) 2008-139545

(51) Int. Cl. H01M 8/04

(52) U.S. Cl. 429/26

(57) ABSTRACT

According to one embodiment, a fuel cell device comprises an electromotive section which is provided with a cell including an anode and a cathode opposed to each other and configured to generate electricity in consequence of a chemical reaction, a fuel tank configured to store a fuel, a fuel channel in which the fuel flows through the anode, an air channel in which air flows through the cathode, a cooling channel which diverges from the fuel channel and extends through the electromotive section, and a fuel supply section configured to supply the fuel from the fuel tank to the anode through the fuel channel and configured to flow some of the fuel from the cooling channel through the electromotive section to cool the electromotive section.

### CROSS-REFERENCE TO RELATED APPLICATIONS

This application is based upon and claims the benefit of priority from Japanese Patent Application No. 2008-139545, filed May 28, 2008, the entire contents of which are incorporated herein by reference.

### BACKGROUND

1. Field

One embodiment of the present invention relates to a fuel cell device used as an energy source for an electronic apparatus or the like.

2. Description of the Related Art

Presently, secondary batteries, such as lithium ion batteries, are mainly used as energy sources for electronic apparatuses, e.g., notebook computers, mobile devices, etc. In recent years, small, high-output fuel cells that require no charging have been expected as new energy sources to meet the demands for increased energy consumption by and prolonged use of these electronic apparatuses with higher functions. Among various types of fuel cells, direct methanol fuel cells (DMFCs) that use a methanol solution as their fuel, in particular, enable easier handling of the fuel and a simpler system configuration, as compared with fuel cells that use hydrogen as their fuel. Thus, DMFCs are obvious energy sources for electronic apparatuses.

As described in Jpn. Pat. Appln. KOKAI Publication No. 2005-293981, for example, a DMFC includes a cell stack in which single cells and separators are alternately laminated to one another. Each single cell is configured so that an electrolyte layer, such as a solid polymer electrolyte membrane, is interposed between two electrodes. The separators are formed with grooves for use as reaction gas channels. The single cell is provided with a membrane electrode assembly (MEA) on each surface of the polymer electrolyte membrane. The MEA integrally includes an anode (fuel electrode) and a cathode (air electrode). An aqueous methanol solution and air are supplied to the anode and the cathode, respectively, through channels in the cell stack.

Oxidation of the fuel occurs in the anode such that methanol is oxidized by reaction with water, whereupon carbon dioxide, protons, and electrons are produced. The protons are transmitted through the polymer electrolyte membrane and move to the cathode. In the cathode, gaseous oxygen in air is coupled to hydrogen ions and electrons and reduced to water. During this process, electrons flow through an external circuit and a current is drawn.

In the fuel cell constructed in this manner, the cell stack tends to produce heat, thereby continually increasing in temperature during electricity generation. In order to generate electricity efficiently, the cell stack itself or the fuel supplied to the cell stack is cooled so that the cell stack is kept at an optimum temperature.

As a method of cooling the cell stack, therefore, a fuel cell with a circulatory liquid cooling system is proposed that is provided with a cooling channel independent of a fuel channel and an air channel such that a coolant is run into the cell stack through the cooling channel.

The cell stack can be kept at a proper temperature by means of the circulatory liquid cooling system described above. However, this system requires the use of ancillary components, such as the independent cooling channel and an independent liquid pump for running the coolant through the cooling channel, so that the entire fuel cell device inevitably becomes larger.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram schematically showing a configuration of a fuel cell device according to a first embodiment of the invention;

FIG. 2 is an exemplary sectional view showing a cell stack of the fuel cell device;

FIG. 3 is an exemplary view schematically showing a single cell of the cell stack;

FIG. 4 is an exemplary block diagram schematically showing a configuration of a fuel cell device according to a second embodiment of the invention;

FIG. 5 is an exemplary view schematically showing a heat exchanger according to a modification; and

FIG. 6 is an exemplary block diagram schematically showing a configuration of a fuel cell device according to a third embodiment of the invention.

### DETAILED DESCRIPTION

Various embodiments according to the invention will be described hereinafter with reference to the accompanying drawings. In general, according to one embodiment of the invention, a fuel cell device comprises: an electromotive section which is provided with a cell including an anode and a cathode opposed to each other and configured to generate electricity in consequence of a chemical reaction; a fuel tank configured to store a fuel; a fuel channel in which the fuel flows through the anode; an air channel in which air flows through the cathode; a cooling channel which diverges from the fuel channel and extends through the electromotive section; and a fuel supply section configured to supply the fuel from the fuel tank to the anode through the fuel channel and configured to flow some of the fuel from the cooling channel through the electromotive section and cool the electromotive section.

A fuel cell device according to a first embodiment of this invention will now be described in detail with reference to the accompanying drawings.

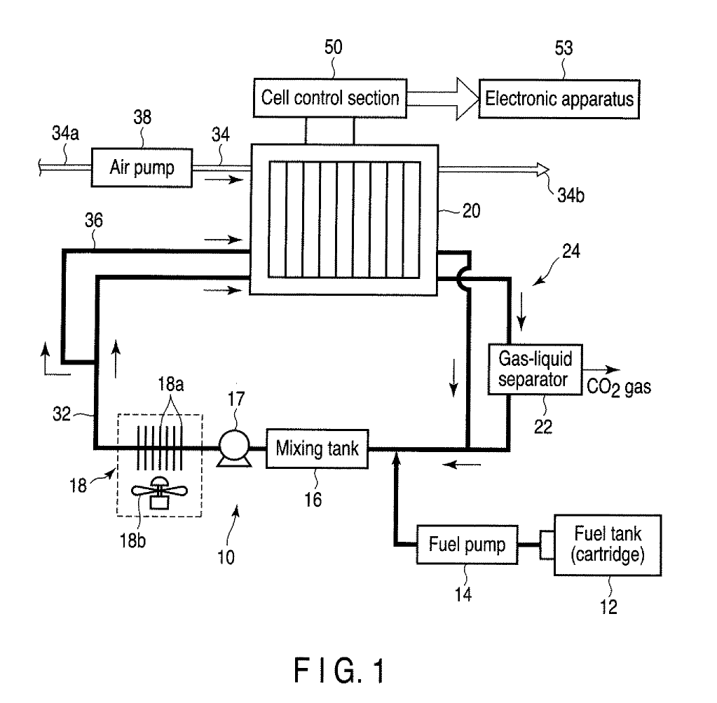

FIG. 1 schematically shows a configuration of the fuel cell device. As shown in FIG. 1, a fuel cell device 10 is constructed as a DMFC that uses methanol as its liquid fuel. The device 10 is provided with a cell stack 20, a fuel tank 12, a circulatory system 24, and a cell control section 50. The cell stack 20 constitutes an electromotive section. The circulatory system 24 supplies the fuel and air to the cell stack. The cell control section 50 controls the operation of the entire fuel cell device.

The fuel tank 12 has a sealed structure and is formed as a fuel cartridge removably attached to the fuel cell device 10. The tank 12 contains highly concentrated methanol for use as the liquid fuel. The fuel tank 12 can be replaced with ease when the fuel has been used up.

The circulatory system 24 includes an anode channel (fuel channel) 32, a cathode channel (air channel) 34, a cooling channel 36, and a plurality of ancillary components. The fuel supplied from the fuel tank 12 is circulated through the anode channel 32 via the cell stack 20. A gas that contains air is circulated through the cathode channel 34 via the cell stack 20. The cooling channel 36 diverges from the anode channel, and some of the fuel is circulated through the cooling channel via the cell stack 20. The ancillary components are incorporated in the fuel and air channels. The anode channel 32, cooling channel 36, and cathode channel 34 are each formed of a pipe or the like.

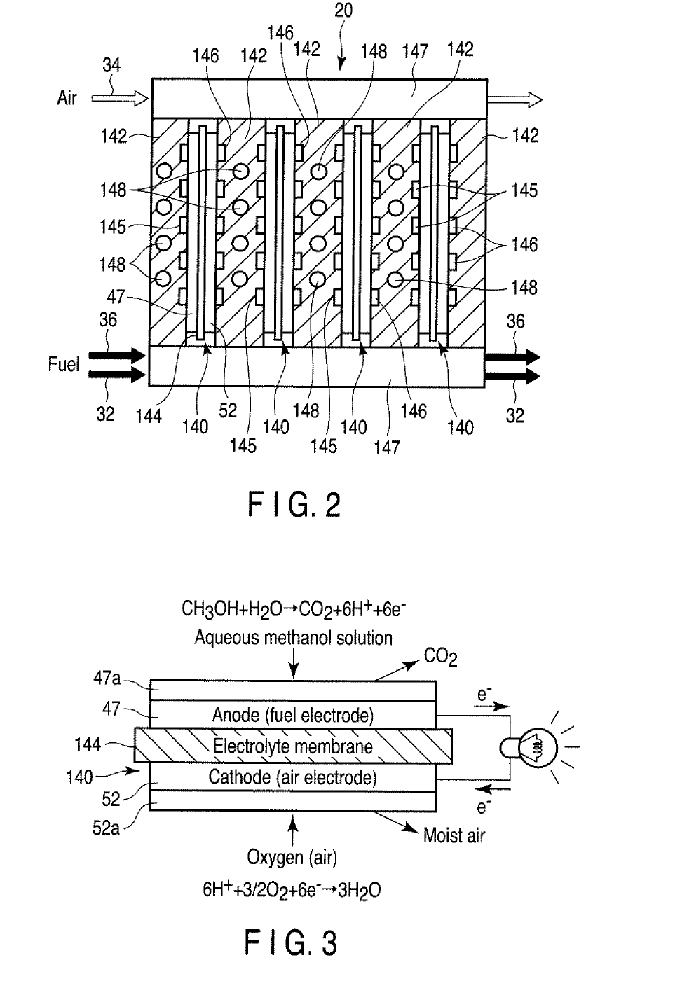

FIG. 2 shows a laminated structure of the cell stack 20, and FIG. 3 typically shows an electricity generating reaction of each single cell. As shown in FIGS. 2 and 3, the cell stack 20 includes a laminate, which is formed by alternately laminating a plurality of, e.g., four, single cells 140 and five rectangular separators 142, and a frame 147 that supports the laminate. Each single cell 140 is provided with a membrane electrode assembly (MEA), which integrally includes a cathode (air electrode) 52, an anode (fuel electrode) 47, and a substantially rectangular polymer electrolyte membrane 144. The cathode 52 and the anode 47 are substantially rectangular sheets each formed of a catalyst layer and a carbon paper. The polymer electrolyte membrane 144 is sandwiched between the cathode and the anode. The anode 47 is formed with a fuel diffusion layer 47a, and the cathode 52 is provided with a porous gas diffusion layer 52a. The polymer electrolyte membrane 144 has an area greater than those of the anode 47 and the cathode 52.

Each of three of the separators 142 is sandwiched between each two adjacent single cells 140, and the other two separators are laminated at the opposite ends in the direction of lamination. The separators 142 and the frame 147 are formed with groove-like fuel channels 145 and groove-like air channels 146. The fuel delivered from the anode channel 32 is supplied to the respective anodes 47 of the single cells 140 through the fuel channels 145. Air is supplied to the respective cathodes 52 of the single cells through the air channels 146. Further, each separator 142 is formed with a plurality of circulation channels 148 through which the cooling fuel delivered from the cooling channel 36 is circulated.

As shown in FIG. 3, the supplied fuel (aqueous methanol solution) and air chemically react with each other in the polymer electrolyte membrane 144 between the anode 47 and the cathode 52. Thereupon, electricity is generated between the anode and the cathode. As this electrochemical reaction progresses, carbon dioxide and water are produced as reaction byproducts on the sides of the anode 47 and the cathode 52, respectively. Electricity generated in the cell stack 20 is supplied to an external device, such as an electronic apparatus 53, through the cell control section 50.

As shown in FIG. 1, an upstream end 34a and a downstream end 34b of the cathode channel 34 individually communicate with the atmosphere. The ancillary components incorporated in the cathode channel 34 include an air pump 38 connected to the cathode channel 34 on the upstream side of the cell stack 20. The air pump 38 constitutes an air supply section that supplies air to the cathode 52.

The ancillary components incorporated in the anode channel 32 includes a fuel pump 14 pipe-connected to a fuel inlet of the fuel tank 12, a mixing tank 16 pipe-connected to an output portion of the fuel pump 14, and a liquid pump 17 connected to an output portion of the mixing tank 16. These ancillary components further include a heat exchanger 18 incorporated in the anode channel 32 between the liquid pump and the cell stack and a gas-liquid separator 22 connected to the anode channel 32 between the output side of the cell stack 20 and the mixing tank 16. The mixing tank 16, along with the fuel tank 12, constitutes a part of a fuel tank according to this invention.

An output portion of the liquid pump 17 is connected to the anode 47 of the cell stack 20 by the anode channel 32. The fuel pump 14 and the liquid pump 17 constitute a fuel supply section that supplies the fuel to the cell stack 20.

The heat exchanger 18 is incorporated in the anode channel 32 between the output portion of the liquid pump 17 and the inlet side of the cell stack 20. The heat exchanger 18 includes, for example, a plurality of radiator fins 18a, which are arranged around a pipe that forms a part of the anode channel 32, and a cooling fan 18b for sending cooling air to the radiator fins. The heat exchanger 18 removes heat from the fuel that flows through the anode channel 32, thereby cooling the fuel.

An output portion of the anode 47 of the cell stack 20 is connected to an input portion of the mixing tank 16 through the anode channel 32 and the gas-liquid separator 22. Exhaust byproducts discharged from the anode 47 of the cell stack 20, that is, carbon dioxide and unreacted aqueous methanol solution, are fed to the gas-liquid separator 22, in which the liquid is separated from the gas. The separated aqueous methanol solution is returned to the mixing tank 16 through the anode channel 32, while the carbon dioxide is discharged to the outside.

The cooling channel 36 diverges from the anode channel 32 at a point between the heat exchanger 18 and the cell stack 20. After passing through the circulation channels 148 of the cell stack 20, the cooling channel 36 joins the anode channel 32 between the cell stack and the mixing tank 16, e.g., between the gas-liquid separator 22 and the mixing tank.

The cell control section 50 supplies the electricity generated in the cell stack 20 to the electronic apparatus 53, measures the voltage of each single cell 140 of the cell stack 20, and performs current control to draw a current from the cell stack.

If the fuel cell device 10 constructed in this manner is used as an energy source for the electronic apparatus 53, the fuel tank 12 that contains methanol is first mounted and connected to the circulatory system 24 of the fuel cell device. In this state, generation of electricity by the fuel cell device 10 is started. In this case, the fuel pump 14, liquid pump 17, and air pump 38 are driven under the control of the cell control section 50. The fuel pump 14 supplies the highly concentrated methanol from the fuel tank 12 to the mixing tank 16 through the anode channel 32. The methanol is mixed with water in the mixing tank and diluted to a predetermined concentration. The aqueous methanol solution diluted in the mixing tank 16 is supplied to the anode 47 of the cell stack 20 through the anode channel 32 and the fuel channels 145 in the cell stack by the liquid pump 17.

The atmosphere or air is drawn into the air channels through the upstream end 34a of the cathode channel 34 by the air pump 38. After passing through an intake filter (not shown), the air is supplied to the cell stack 20 through the cathode channel 34 and then to the cathodes 52 of the cell stack through the air channels 146 of the cell stack.

The aqueous methanol solution and the air supplied to the cell stack 20 react electrochemically with each other in the polymer electrolyte membrane 144 between the anode 47 and the cathode 52, thereby generating electricity between the anode and the cathode. The electricity generated in the cell stack 20 allows a current to be drawn from the cell stack by the cell control section 50 and supplied to the electronic apparatus 53.

As the electrochemical reaction progresses, carbon dioxide and water are produced as reaction byproducts on the sides of the anode 47 and the cathode 52, respectively, in the cell stack 20. The carbon dioxide produced on the side of the anode 47 and the unreacted aqueous methanol solution are fed through the anode channel 32 to the gas-liquid separator 22, in which they are separated from each other. The aqueous methanol solution is delivered from the gas-liquid separator 22 to the mixing tank 16 through the anode channel 32 and used again for generation of electricity. The separated carbon dioxide is discharged to the outside from the gas-liquid separator 22.

Steam produced on the side of the cathode 52 of the cell stack 20 is discharged to the outside through the downstream end of the cathode channel 34.

During the electricity generation by the fuel cell device 10, on the other hand, the cell stack tends to produce heat, thereby continually increasing in temperature. According to the fuel cell device described above, the fuel supplied to the cell stack 20 by the liquid pump 17 is deprived of heat and cooled by the heat exchanger 18. Thereafter, some of the fuel is fed to the circulation channels 148 of the cell stack 20 through the cooling channel 36. The fuel cools the cell stack 20 as it flows through the circulation channels 148. Thereafter, the fuel flows through the cooling channel 36 into the anode channel 32 and is returned to the mixing tank 16. Thus, by supplying some of the fuel as the coolant to the cell stack 20 to cool it, the cell stack 20 can be kept at a temperature suitable for electricity generation.

According to the fuel cell device constructed in this manner, the cell stack 20 can be efficiently cooled by utilizing some of the fuel if it is heated by electricity generation. Further, the cell stack 20 is configured to be supplied with the coolant through the cooling channel that diverges from the anode channel and by means of the pump that also serves for fuel supply. Therefore, it is unnecessary to provide an independent circulation channel or an ancillary component, such as an independent liquid pump for running the coolant through the circulation channel, so that the fuel cell device can be kept small. Thus, there is obtained a fuel cell device that can be made smaller and in which the cells can be cooled efficiently.

The following is a description of a fuel cell device according to a second embodiment of the invention.

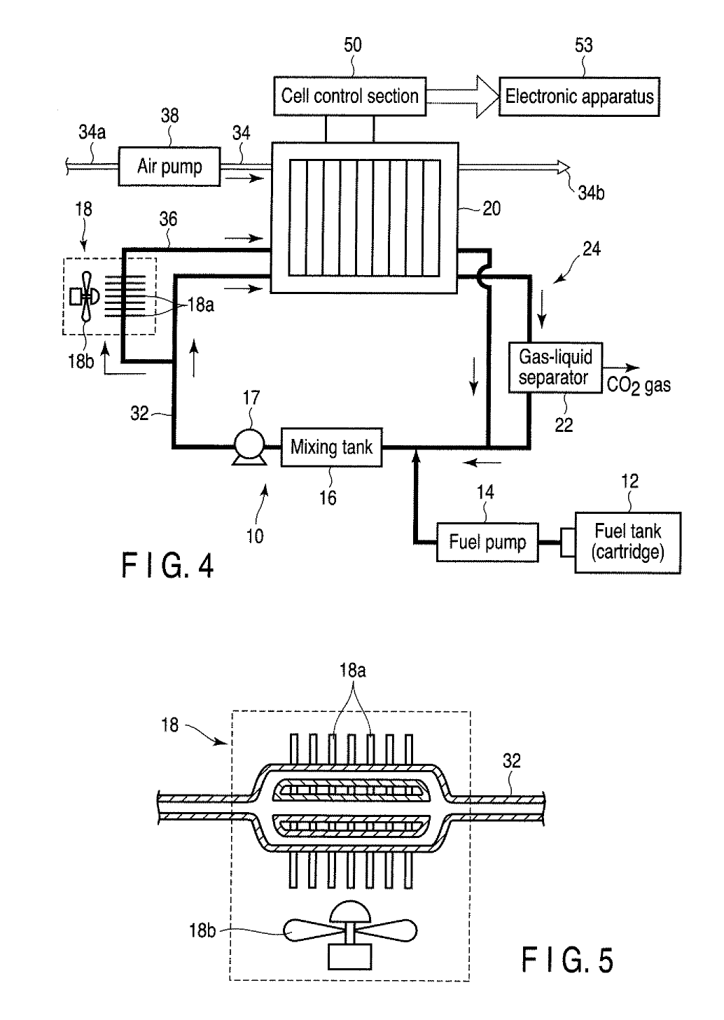

FIG. 4 schematically shows a fuel cell device 10 of the second embodiment. According to the second embodiment, a heat exchanger 18 is incorporated in a cooling channel 36 between the output side of a liquid pump 17 and the inlet side of a cell stack 20. The heat exchanger 18 includes, for example, a plurality of radiator fins 18a, which are arranged around a pipe that forms the cooling channel 36, and a cooling fan 18b for delivering cooling air to the radiator fins. The heat exchanger 18 removes heat from a fuel that flows through the cooling channel 36, thereby cooling the fuel.

FIG. 5 shows a heat exchanger according to a modification. In this heat exchanger 18, a part of a fuel channel 32 diverges into a plurality of, e.g., three, branch channels, which join together again. A plurality of radiator fins 18a are mounted across three pipes that individually define the three branch channels. The heat exchanger 18 includes a cooling fan 18b for delivering cooling air to the radiator fins 18a.

By using the heat exchanger 18 constructed in this manner, the fuel can be cooled more efficiently, and some of the fuel can be utilized to cool the cell stack.

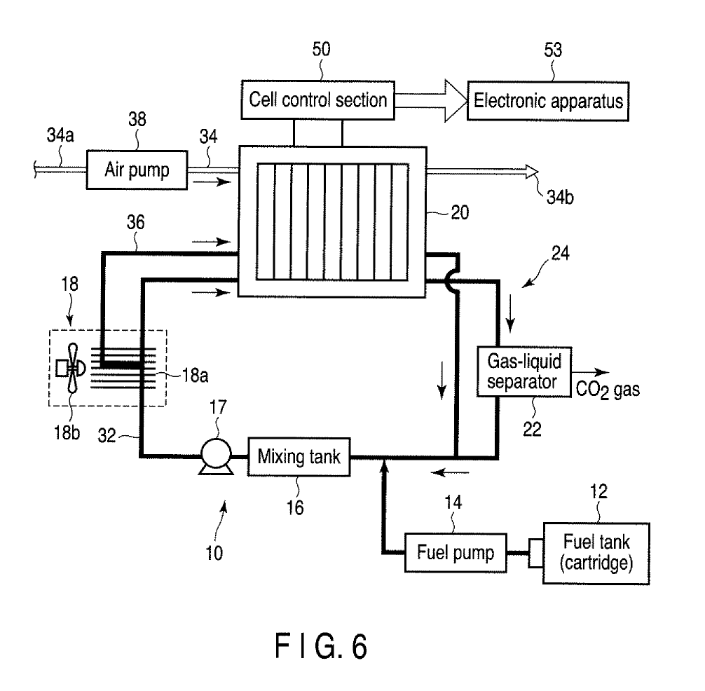

FIG. 6 schematically shows a fuel cell device 10 according to a third embodiment. In the third embodiment, a heat exchanger 18 is provided at the junction of an anode channel 32 and a cooling channel 36 between the output side of a liquid pump 17 and the inlet side of a cell stack 20. The heat exchanger 18 includes a plurality of radiator fins 18a, which are arranged across pipes that form the anode channel 32 and the cooling channel 36, and a cooling fan 18b for delivering cooling air to the radiator fins. The heat exchanger 18 removes heat from a fuel that flows through the anode channel 32 and the cooling channel 36, thereby cooling the fuel.

Other configurations of the fuel cell devices 10 of the second and third embodiments are the same as those of the foregoing first embodiment. Therefore, like reference numbers are used to designate like portions of these embodiments, and a detailed description thereof is omitted. Further, the same functions and effects as those of the first embodiment can be obtained with the second and third embodiments. According to the third embodiment, the fuel that flows through both the cooling channel and the anode channel is cooled, so that the cell stack can be cooled more efficiently.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the fuel cell device may be configured so that air is supplied to the cell stack by diffusion and convection without using the air pump. The number of single cells in the cell stack is not limited to those described in connection with the above embodiments and may be varied as required. The fuel cell device according to this invention is also applicable to energy sources for various electronic apparatuses, such as personal computers, mobile devices, portable terminals, etc., and other apparatuses.

What is claimed is:

1. A fuel cell device comprising:
an electromotive section which is provided with a cell including an anode and a cathode opposed to each other and configured to generate electricity in consequence of a chemical reaction;
a fuel tank configured to store a fuel;
a fuel channel in which the fuel flows through the anode;
an air channel in which air flows through the cathode;
a cooling channel which diverges from the fuel channel and extends through the electromotive section; and
a fuel supply section configured to supply the fuel from the fuel tank to the anode through the fuel channel and configured to flow some of the fuel from the cooling channel through the electromotive section and cool the electromotive section.

2. The fuel cell device of claim 1, wherein the cooling channel diverges from the fuel channel between the fuel tank and the electromotive section and joins the fuel channel between the electromotive section and the fuel tank after passing through the electromotive section.

3. The fuel cell device of claim 1, further comprising a heat exchanger which is incorporated in the fuel channel and configured to cool the fuel flowing through the fuel channel.

4. The fuel cell device of claim 1, further comprising a heat exchanger which is incorporated in the cooling channel and configured to cool the fuel flowing through the cooling channel.

5. The fuel cell device of claim 1, further comprising a heat exchanger which is provided at a junction of the fuel channel and the cooling channel and configured to cool the fuel flowing through the cooling channel and the cooling channel.

6. The fuel cell device of claims 1, wherein the electromotive section is provided with a cell stack formed by alternately laminating a plurality of single cells, each of the single cells including an anode and a cathode opposed to each other with a polymer membrane therebetween, and separators formed with channels to one another, and the cooling channel extends through the separators.
